(19) United States
(12) Patent Application Publication
(10) Pub. No.: US 2007/0009823 A1
(43) Pub. Date: Jan. 11, 2007

(54) Toner and developer compositions

(75) Inventors: Vladislav Skorokhod, Mississauga (CA); Maria N.V. McDougall, Burlington (CA); Wafa F. Bashir, Mississauga (CA); Richard P.N. Veregin, Mississauga (CA); Mary B. Schlitzer, Rochester, NY (US)

Correspondence Address: OLIFF & BERRIDGE, PLC., P.O. BOX 19928, ALEXANDRIA, VA, 22320, US

(73) Assignee: XEROX CORPORATIOND, Stamford, CT (US)

(21) Appl. No.: 11/176,223

(22) Filed: Jul. 8, 2005

(51) Int. Cl. G03G 9/08

(52) U.S. Cl. 430/108.3; 430/108.6; 430/108.7; 430/109.1; 430/137.14

(57) ABSTRACT

A toner composition includes toner particles of at least a resin, a wax, and a colorant, and external additives applied on an exterior surface of the toner particles, including silica, titania, and spacer particles.

### TECHNICAL FIELD

This disclosure is generally directed to toner compositions and processes and more specifically directed to toner compositions and processes, such as emulsion aggregation toner processes, for preparing toner compositions comprising a resin; a wax; and a colorant, and a surface additive package comprising silica, titania, and spacer particles.

### RELATED APPLICATIONS

Commonly assigned, co-pending U.S. patent application Ser. No. 11/003,581 filed Dec. 3, 2004, of Raj D. Patel et al. and entitled “Toner Compositions,” which is hereby incorporated by reference herein in its entirety, describes toner compositions comprising a non cross linked resin; a cross linked resin or gel; a wax; and a colorant. Processes for preparing a toner comprise mixing a non-cross linked resin and a cross-linked resin or gel in the presence of a wax, a colorant, and a coagulant to provide toner size aggregates; adding additional non-cross linked latex to the formed aggregates thereby providing a shell over the formed aggregates; heating the shell covered aggregates to form toner; and, optionally, isolating the toner.

### BACKGROUND

For both black and color prints, a small particle size toner is known to improve the image quality of the prints, and reduce toner consumption. High speed black and white printers require toner particles that can provide a matte finish in an oil-less fuser system with a low minimum fixing temperature (MFT) to enable high speed printing and at the same time achieve superior image quality in the resultant printed product.

U.S. Pat. No. 6,447,974 describes in the Abstract a process for the preparation of a latex polymer by (i) preparing or providing a water aqueous phase containing an anionic surfactant in an optional amount of less than or equal to about 20 percent by weight of the total amount of anionic surfactant used in forming the latex polymer; (ii) preparing or providing a monomer emulsion in water which emulsion contains an anionic surfactant; (iii) adding about 50 percent or less of said monomer emulsion to said aqueous phase to thereby initiate seed polymerization and to form a seed polymer, said aqueous phase containing a free radical initiator; and (iv) adding the remaining percent of said monomer emulsion to the composition of (iii) and heating to complete an emulsion polymerization thus forming a latex polymer.

U.S. Pat. No. 6,413,692 describes in the Abstract a process comprising coalescing a plurality of latex encapsulated colorants and wherein each of said encapsulated colorants are generated by miniemulsion polymerization.

U.S. Pat. No. 6,309,787 describes in the Abstract a process comprising aggregating a colorant encapsulated polymer particle containing a colorant with colorant particles and wherein said colorant encapsulated latex is generated by a miniemulsion polymerization.

U.S. Pat. No. 6,294,306 describes in the Abstract toners which include one or more copolymers combined with colorant particles or primary toner particles and a process for preparing a toner comprising (i) polymerizing an aqueous latex emulsion comprising one or more monomers, an optional nonionic surfactant, an optional anionic surfactant, an optional free radical initiator, an optional chain transfer agent, and one or more copolymers to form emulsion resin particles having the one or more copolymers dispersed therein; (ii) combining the emulsion resin particle with colorant to form statically bound aggregated composite particles; (iii) heating the statically bound aggregated composite particles to form toner; and (iv) optionally isolating the toner.

U.S. Pat. No. 6,130,021 describes in the Abstract a process involving the mixing of a latex emulsion containing resin and a surfactant with a colorant dispersion containing a nonionic surfactant, and a polymeric additive and adjusting the resulting mixture pH to less than about 4 by the addition of an acid and thereafter heating at a temperature below about, or equal to about, the glass transition temperature (Tg) of the latex resin, subsequently heating at a temperature above about, or about equal to, the Tg of the latex resin, cooling to about room temperature, and isolating the toner product.

U.S. Pat. No. 5,928,830 describes in the Abstract a process for the preparation of a latex comprising a core polymer and a shell thereover and wherein the core polymer is generated by (A) (i) emulsification and heating of the polymerization reagents of monomer, chain transfer agent, water, surfactant, and initiator; (ii) generating a seed latex by the aqueous emulsion polymerization of a mixture comprised of part of the (i) monomer emulsion, from about 0.5 to about 50 percent by weight, and a free radical initiator, and which polymerization is accomplished by heating, and, wherein the reaction of the free radical initiator and monomer produces a seed latex containing a polymer; (iiij heating and adding to the formed seed particles of (ii) the remaining monomer emulsion of (I), from about 50 to about 99.5 percent by weight of monomer emulsion of (i) and free radical initiator; (iv) whereby there is provided said core polymer; and (B) forming a shell thereover said core generated polymer and which shell is generated by emulsion polymerization of a second monomer in the presence of the core polymer, which emulsion polymerization is accomplished by (i) emulsification and heating of the polymerization reagents of monomer, chain transfer agent, surfactant, and an initiator; (ii) adding a free radical initiator and heating; (iii) whereby there is provided said shell polymer.

U.S. Pat. No. 5,869,216 describes in the Abstract a process for the preparation of toner comprising blending an aqueous colorant dispersion and a latex emulsion containing resin; heating the resulting mixture at a temperature below about the glass transition temperature (Tg) of the latex resin to form toner sized aggregates; heating said resulting aggregates at a temperature above about the Tg of the latex resin to effect fusion or coalescence of the aggregates; redispersing said toner in water at a pH of above about 7; contacting the resulting mixture with a metal halide or salt, and then with a mixture of an alkaline base and a salicylic acid, a catechol, or mixtures thereof at a temperature of from about 25 degrees C. to about 80 degrees C.; and optionally isolating the toner product, washing, and drying. Additional patents of interest include U.S. Pat. No. 5,766,818; U.S. Pat. No. 5,344,738; and U.S. Pat. No. 4,291,111.

The disclosures of each of the foregoing U.S. Patents are hereby incorporated by reference herein in their entireties. The appropriate components and process aspects of the each of the foregoing U.S. Patents may be selected for the present compositions and processes in embodiments thereof.

There remains a need for an improved toner composition and process that overcomes or alleviates the above-described and other problems experienced in the art. There further remains a need for a toner composition suitable for high speed printing, particularly high speed monochrome printing that can provide excellent release and hot offset characteristics, minimum fixing temperature, and suitable small toner particle size characteristics.

There also remains a need in the art for suitable small-sized toner particles, which can be advantageously used in printing processes that require lower toner mass per area. For example, a toner having an average particle size of 9 micrometers or more provides a relatively high toner mass per area when developing images. The ability to provide toners with smaller average particle size would allow lower toner mass per area, and thus reduction in toner consumption.

### SUMMARY

This disclosure addresses some or all of the above problems, and others, by providing improved toners and developers, and methods for making such improved toners and developers.

A toner composition and a process for preparing a toner including, for example, an emulsion aggregation process for preparing a toner, are described. The toner composition comprises, for example, a resin, such as a single resin or a mixture or combination of multiple resins such as a resin substantially free of cross linking and a cross linked resin; a wax; and a colorant. For example, a resin that is substantially free of cross linking (also referred to herein as a non cross linked resin) comprises a resin having substantially about zero percent cross linking to about 0.1 percent cross linking. For example, a cross linked resin comprises a cross linked resin or gel comprising, for example, about 0.3 percent cross linking to about 20 percent cross linking. The toner also comprises external additives comprising, for example, at least a silica, a titania, and a spacer particle.

A process for preparing a toner comprises, for example, mixing a resin, such as a single resin or a mixture or combination of multiple resins such as a resin substantially free of cross linking and a cross-linked resin, in the presence of a wax, a colorant, and a coagulant to provide toner size aggregates; optionally adding additional resin substantially free of cross linking to the formed aggregates thereby providing a shell over the formed aggregates; heating the shell covered aggregates to form toner; and, optionally, isolating the toner. In embodiments, the heating comprises a first heating below the glass transition temperature of the resin substantially free of cross linking and a second heating above the glass transition temperature of the resin substantially free of cross linking. In embodiments, the toner process comprises providing an anionic surfactant in an amount of for example about 0.01% to about 20% by weight based upon a total weight of the reaction mixture, wherein the anionic surfactant is selected for example from the group consisting of sodium dodecylsulfate, sodium dodecylbenzene sulfonate, sodium dodecylnaphthalene sulfate, dialkyl benzenealkyl, sulfates, sulfonates, adipic acid, hexa decyldiphenyloxide disulfonate, or mixtures thereof. In embodiments, the toner process provides a shell having a thickness of for example about 0.3 to about 0.8 micrometers. The process also comprises applying to the toner external additives comprising, for example, at least a silica, a titania, and a spacer particle.

The toners generated with the present processes are especially useful for imaging processes, especially xerographic processes. The toners advantageously provide characteristics that meet reprographic machine requirements such as minimum fixing temperature, wide fusing latitude, good release, low gloss, robust particles, triboelectrical properties, and development at high speeds such as speeds of about 150 ppm and above.

In an embodiment, the present disclosure provides a toner composition comprising:

toner particles comprising a resin, a wax, and a colorant; and

external additives applied on an exterior surface of said toner particles, comprising silica, titania, and spacer particles.

The disclosure also provides developers containing such toner particles, and a carrier.

In another embodiment, the present disclosure provides a method of making a toner, comprising:

mixing at least resin particles, colorant particles, and a coagulant;

forming toner size aggregates in said mixture by an emulsion aggregation process;

optionally adding additional resin substantially free of cross linking to the formed aggregates to provide a shell over the formed aggregates;

optionally isolating the toner size aggregates; and

applying on an exterior surface of said toner size aggregates external additives comprising silica, titania, and spacer particles.

These and other features and advantages will be more fully understood from the following description of certain specific embodiments taken together with the accompanying claims.

### DETAILED DESCRIPTION OF PREFERRED EMBODIMENTS

Toner compositions will now be described comprising a resin, such as a mixture or combination of a non cross linked resin and a cross linked resin or gel; and a colorant, and an external additive package comprising at least a silica, a titania, and a spacer particle; and a process for preparing a toner comprising mixing a non cross linked resin and a cross linked resin in the presence of a wax, a colorant, and a coagulant to provide toner size aggregates; optionally adding additional non cross linked latex to the formed aggregates thereby providing a shell over the formed aggregates; heating the shell covered aggregates to form toner; optionally, isolating the toner; and applying an external additive package comprising at least a silica, a titania, and a spacer particle. In embodiments, the toner process includes providing an anionic surfactant in an amount of for example about 0.01% to about 20% by weight based upon a total weight of the reaction mixture; wherein for example the anionic surfactant is selected from the group consisting of sodium dodecylsulfate, sodium dodecylbenzene sulfonate, sodium dodecylnaphthalene sulfate, dialkyl benzenealkyl, sulfates, sulfonates, adipic acid, hexa decyldiphenyloxide disulfonate, or mixtures thereof. In further embodiments, the shell thus formed has, for example, a thickness of about 0.3 to about 0.8 micrometers.

Latex Resins or Polymers

Illustrative examples of latex resins or polymers selected for the non cross linked resin and cross linked resin or gel include, but are not limited to, styrene acrylates, styrene methacrylates, butadienes, isoprene, acrylonitrile, acrylic acid, methacrylic acid, beta-carboxy ethyl acrylate, polyesters, known polymers such as poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and the like. In embodiments, the resin or polymer is a styrene/butyl acrylate/carboxylic acid terpolymer. In embodiments, at least one of the resin substantially free of cross linking and the cross linked resin comprises carboxylic acid in an amount of about 0.05 to about 10 weight percent based upon the total weight of the resin substantially free of cross linking or cross linked resin.

In embodiments, the resin used in forming the toner particles can be one type of resin, or a mixture or combination of two or more types of resins. For example, a single resin (non cross linked or cross linked) can be used to form the toner particles. Alternatively the toner particles can be formed by using a mixture of two or more resins, which are added together or separately, at the same time or not, during the formation process. Preferably, in some embodiments, the resin used comprises two resins, one of which is non cross linked and the other of which is cross linked.

Non Cross Linked Resin

In embodiments, the resin that is substantially free of cross linking (also referred to herein as a non cross linked resin) comprises a resin having less than about 0.1 percent cross linking. For example, the non cross linked latex comprises in embodiments styrene, butylacrylate, and beta-carboxy ethyl acrylate (beta-CEA) monomers, although not limited to these monomers, termed herein as monomers A, B, and C, prepared, for example, by emulsion polymerization in the presence of an initiator, a chain transfer agent (CTA), and surfactant.

In embodiments, the resin substantially free of cross linking comprises styrene:butylacrylate:beta-carboxy ethyl acrylate wherein, for example, the non cross linked resin monomers are present in an amount of about 70% to about 90% styrene, about 10% to about 30% butylacrylate, and about 0.05 parts per hundred to about 10 parts per hundred beta-CEA, or about 3 parts per hundred beta-CEA, by weight based upon the total weight of the monomers, although not limited. For example, the carboxylic acid can be selected, for example, from the group comprised of, but not limited to, acrylic acid, methacrylic acid, itaconic acid, beta carboxy ethyl acrylate (beta CEA), fumaric acid, maleic acid, and cinnamic acid.

In a feature herein, the non cross linked resin comprises about 73% to about 85% styrene, about 27% to about 15% butylacrylate, and about 1.0 part per hundred to about 5 parts per hundred beta-CEA, by weight based upon the total weight of the monomers although the compositions and processes are not limited to these particular types of monomers or ranges. In another feature, the non cross linked resin comprises about 81.7% styrene, about 18.3% butylacrylate and about 3.0 parts per hundred beta-CEA by weight based upon the total weight of the monomers.

The initiator may be, for example, but is not limited to, sodium, potassium or ammonium persulfate and may be present in the range of, for example, about 0.5 to about 3.0 percent based upon the weight of the monomers, although not limited. The CTA may be present in an amount of from about 0.5 to about 5.0 percent by weight based upon the combined weight of the monomers A and B, although not limited. In embodiments, the surfactant is an anionic surfactant present in the range of about 0.7 to about 5.0 percent by weight based upon the weight of the aqueous phase, although not limited to this type or range.

For example, the monomers are polymerized under starve fed conditions as referred to in Xerox patents such as U.S. Pat. No. 6,447,974, U.S. Pat. No. 6,576,389, U.S. Pat. No. 6,617,092, and U.S. Pat. No. 6,664,017, which are hereby incorporated by reference herein in their entireties, to provide latex resin particles having a diameter in the range of about 100 to about 300 nanometers.

For example, the molecular weight of the non cross linked latex resin is from about 30,000 to about 37,000, preferably about 34,000, although not limited to this range.

In embodiments, the onset glass transition temperature (TG) of the non cross linked resin is in the range of, for example, from about 46° C. to about 62° C., or about 58° C., although not limited.

In embodiments, the amount of carboxylic acid groups is selected in the range of about 0.04 to about 4.0 pph of the resin monomers A and B, although not limited.

In embodiments, the molecular number (Mn) is from about 5000 to about 20,000, or about 11,000.

In embodiments, the prepared non cross linked latex resin has a pH of about 1.0 to about 4.0, or about 2.0.

Cross Linked Resin or Gel

For example, a cross linked latex is prepared from a non cross linked latex comprising styrene, butylacrylate, beta-CEA, and divinyl benzene, termed herein as monomers A, B, C, and D, by emulsion polymerization, in the presence of an initiator such as a persulfate, a CTA, and a surfactant. In embodiments, the cross linked resin monomers are present in a ratio of about 60% to about 75% styrene, about 40% to about 25% butylacrylate, about 3 parts per hundred to about 5 parts per hundred beta-CEA, and about 3 parts per hundred to about 5 parts per hundred divinyl benzene, although not limited to these particular types of monomers or ranges. Any of the above-described monomers can also be used for forming the cross linked latex or gel, as desired.

In embodiments, the monomer composition may comprise, for example, about 65% styrene, 35% butylacrylate, 3 parts per hundred beta-CEA, and about 1 parts per hundred divinyl benzene, although the composition is not limited to these amounts.

In embodiments, the Tg (onset) of the cross linked latex is about 40° C. to about 55° C. or about 42° C.

In embodiments, the degree of cross linking is in the range of about 0.3 percent to about 20 percent, although not limited thereto, since an increase in the divinyl benzene concentration will increase the cross linking.

In embodiments, the soluble portion of the cross linked latex has a molecular weight (Mw) of about 135,000 and a molecular number (Mn) of about 27,000, but is not limited thereto.

In embodiments, the particle diameter size of the cross linked latex is about 20 to about 250 nanometers or about 50 nanometers, although not limited.

The surfactant may be any surfactant, such as for example a nonionic surfactant or an anionic surfactant, such as, but not limited to, Neogen RK or Dowfax, both commercially available.

In embodiments, the pH is about 1.5 to about 3.0 or about 1.8.

In embodiments, the latex particle size can be, for example, from about 0.05 micron to about 1 micron in average volume diameter as measured by the Brookhaven nanosize particle analyzer. Other sizes and effective amounts of latex particles may be selected in embodiments.

The latex resins selected for the present process are prepared, for example, by emulsion polymerization methods, and the monomers utilized in such processes preferably include the monomers listed above, such as, styrene, acrylates, methacrylates, butadiene, isoprene, acrylonitrile, acrylic acid, and methacrylic acid, and beta CEA. Known chain transfer agents, for example dodecanethiol, in effective amounts of, for example, from about 0.1 to about 10 percent, and/or carbon tetrabromide in effective amounts of from about 0.1 to about 10 percent, can also be employed to control the resin molecular weight during the polymerization.

Other processes of obtaining resin particles of from, for example, about 0.05 micron to about 1 micron can be selected from polymer microsuspension process, such as the processes disclosed in U.S. Pat. No. 3,674,736, the disclosure of which is totally incorporated herein by reference, polymer solution microsuspension processes, such as disclosed in U.S. Pat. No. 5,290,654, the disclosure of which is totally incorporated herein by reference, mechanical grinding processes, or other known processes.

Surfactants

For example, surfactants in amounts of, for example, about 0.01 to about 20, or about 0.1 to about 15 weight percent of the reaction mixture in embodiments include, for example, nonionic surfactants such as dialkylphenoxypoly(ethyleneoxy) ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210.™, ANTAROX 890™ and ANTAROX 897.™ For example, an effective concentration of the nonionic surfactant is in embodiments, for example, about 0.01 percent to about 10 percent by weight, or about 0.1 percent to about 5 percent by weight of the reaction mixture.

Examples of anionic surfactants being, for example, sodium dodecylsulfate (SDS), sodium dodecylbenzene sulfonate, sodium dodecylnaphthalene sulfate, dialkyl benzenealkyl, sulfates and sulfonates, adipic acid, available from Aldrich, NEOGEN R.™, NEOGEN SC.™, available from Kao, Dowfax 2A1 (hexa decyldiphenyloxide disulfonate) and the like, among others. For example, an effective concentration of the anionic surfactant generally employed is, for example, about 0.01 percent to about 10 percent by weight, or about 0.1 percent to about 5 percent by weight of the reaction mixture

Examples of bases used to increase the pH and hence ionize the aggregate particles thereby providing stability and preventing the aggregates from growing in size can be selected from sodium hydroxide, potassium hydroxide, ammonium hydroxide, cesium hydroxide and the like, among others.

Examples of additional surfactants, which may be added optionally to the aggregate suspension prior to or during the coalescence to, for example, prevent the aggregates from growing in size, or for stabilizing the aggregate size, with increasing temperature can be selected from anionic surfactants such as sodium dodecylbenzene sulfonate, sodium dodecylnaphthalene sulfate, dialkyl benzenealkyl, sulfates and sulfonates, adipic acid, available from Aldrich, NEOGEN R.™, NEOGEN SC™ available from Kao, and the like, among others. These surfactants can also be selected from nonionic surfactants such as polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy) ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. For example, an effective amount of the anionic or nonionic surfactant generally employed as an aggregate size stabilization agent is, for example, about 0.01 percent to about 10 percent or about 0.1 percent to about 5 percent, by weight of the reaction mixture.

Examples of the acids that can be utilized include, for example, nitric acid, sulfuric acid, hydrochloric acid, acetic acid, citric acid, trifluoro acetic acid, succinic acid, salicylic acid and the like, and which acids are in embodiments utilized in a diluted form in the range of about 0.5 to about 10 weight percent by weight of water or in the range of about 0.7 to about 5 weight percent by weight of water.

Wax

For example, wax suitable for the present toner compositions include, but are not limited to, alkylene waxes such as alkylene wax having about 1 to about 25 carbon atoms, polyethylene, polypropylene or mixtures thereof. The wax is present, for example, in an amount of about 6% to about 15% by weight based upon the total weight of the composition. Examples of waxes include those as illustrated herein, such as those of the aforementioned co-pending applications, polypropylenes and polyethylenes commercially available from Allied Chemical and Petrolite Corporation, wax emulsions available from Michaelman Inc. and the Daniels Products Company, Epolene N-15™ commercially available from Eastman Chemical Products, Inc., Viscol 550-P™, a low weight average molecular weight polypropylene available from Sanyo Kasei K.K., and similar materials. The commercially available polyethylenes possess, it is believed, a molecular weight (Mw) of about 1,000 to about 5,000, and the commercially available polypropylenes are believed to possess a molecular weight of about 4,000 to about 10,000. Examples of functionalized waxes include amines, amides, for example Aqua Superslip 6550™, Superslip 6530™ available from Micro Powder Inc., fluorinated waxes, for example Polyfluo 190™, Polyfluo 200™, Polyfluo 523XF™, Aqua Polyfluo 41 ™, Aqua Polysilk 19™, Polysilk 14™ available from Micro Powder Inc., mixed fluorinated, amide waxes, for example Microspersion 19™ also available from Micro Powder Inc., imides, esters, quaternary amines, carboxylic acids or acrylic polymer emulsion, for example Joncryl 74™, 89™, 130™, 537™, and 538™, all available from SC Johnson Wax, chlorinated polypropylenes and polyethylenes available from Allied Chemical and Petrolite Corporation and SC Johnson Wax.

In embodiments, the wax comprises a wax in the form of a dispersion comprising, for example, a wax having a particle diameter of about 100 nanometers to about 500 nanometers, water, and an anionic surfactant. In embodiments, the wax is included in amounts such as about 6 to about 15 weight percent. In embodiments, the wax comprises polyethylene wax particles, such as Polywax 850, commercially available from Baker Petrolite, although not limited thereto, having a particle diameter in the range of about 100 to about 500 nanometers, although not limited. The surfactant used to disperse the wax is an anionic surfactant, although not limited thereto, such as, for example, Neogen RK™ commercially available from Kao Corporation or TAYCAPOWER BN2060 commercially available from Tayca Corporation.

Pigment/Colorant

For example, colorants or pigments as used herein include pigment, dye, mixtures of pigment and dye, mixtures of pigments, mixtures of dyes, and the like. For simplicity, the term “colorant” as used herein is meant to encompass such colorants, dyes, pigments, and mixtures, unless specified as a particular pigment or other colorant component. In embodiments, the colorant comprises a pigment, a dye, mixtures thereof, carbon black, magnetite, black, cyan, magenta, yellow, red, green, blue, brown, mixtures thereof, in an amount of about 1% to about 25% by weight based upon the total weight of the composition. It is to be understood that other useful colorants will become readily apparent to one of skill in the art based on the present disclosures.

In general, useful colorants include, but are not limited to, Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF) and particularly carbon blacks such as REGAL 330 (Cabot), Carbon Black 5250 and 5750 (Columbian Chemicals), and the like or mixtures thereof.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof. Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta EO2 which can be dispersed in water and/or surfactant prior to use.

Other useful colorants include, for example, magnetites, such as Mobay magnetites MO8029, MO8960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like or mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide) phthalocyanine, x-copper phthalocyanine pigment listed in the Color Index as CI74160, CI Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components may also be selected as pigments.

Coagulant

In a featured embodiment, the coagulants used in the present process comprise poly metal halides, such as polyaluminum chloride (PAC) or polyaluminum sulfo silicate (PASS). For example, the coagulants provide a final toner having a metal content of, for example, about 400 to about 10,000 parts per million. In another feature, the coagulant comprises a poly aluminum chloride providing a final toner having an aluminum content of about 400 to about 10,000 parts per million.

Toner Particle Preparation

For example, emulsion/aggregation/coalescing processes for the preparation of toners are illustrated in a number of Xerox patents, the disclosures of each of which are totally incorporated herein by reference, such as U.S. Pat. Nos. 5,290,654, 5,278,020, 5,308,734, 5,370,963, 5,344,738, 5,403,693, 5,418,108, 5,364,729, and 5,346,797. Also of interest are U.S. Pat. Nos. 5,348,832; 5,405,728; 5,366,841; 5,496,676; 5,527,658; 5,585,215; 5,650,255; 5,650,256; 5,501,935; 5,723,253; 5,744,520; 5,763,133; 5,766,818; 5,747,215; 5,827,633; 5,853,944; 5,804,349; 5,840,462; 5,869,215; 5,863,698; 5,902,710; 5,910,387; 5,916,725; 5,919,595; 5,925,488; and 5,977,210, the disclosures of each of which are hereby totally incorporated herein by reference. In addition, Xerox patents U.S. Pat. Nos. 6,627,373; 6,656,657; 6,617,092; 6,638,677; 6,576,389; 6,664,017; 6,656,658; and 6,673,505 are each hereby totally incorporated herein by reference. The appropriate components and process aspects of each of the foregoing U.S. Patents may be selected for the present composition and process in embodiments thereof.

In embodiments thereof, the toner process comprises forming a toner particle by mixing a resin, such as a mixture or combination of the non cross linked latex with a quantity of the cross linked latex, in the presence of a wax and a pigment dispersion to which is added a coagulant of a poly metal halide such as polyaluminum chloride while blending at high speeds such as with a polytron. The resulting mixture having a pH of about 2.0 to about 3.0 is aggregated by heating to a temperature below the resin Tg to provide toner size aggregates. Optionally, additional non cross linked latex is added to the formed aggregates providing a shell over the formed aggregates. The pH of the mixture is then changed by the addition of a sodium hydroxide solution until a pH of about 7.0 is achieved. When the mixture reaches a pH of about 7.0, the carboxylic acid becomes ionized to provide additional negative charge on the aggregates thereby providing stability and preventing the particles from further growth or an increase in the size distribution when heated above the Tg of the latex resin. The temperature of the mixture is then raised to about 95° C. After about 30 minutes, the pH of the mixture is reduced to a value sufficient to coalesce or fuse the aggregates to provide a composite particle upon further heating such as about 4.5. The fused particles are measured for shape factor or circularity, such as with a Sysmex FPIA 2100 analyzer, until the desired shape is achieved.

The mixture is allowed to cool to room temperature and is washed. A first wash is conducted such as at a pH of about 10 and a temperature of about 63° C. followed by a deionized water (DIW) wash at room temperature. This is followed by a wash at a pH of about 4.0 at a temperature of about 40° C. followed by a final DIW water wash. The toner is then dried.

While not wishing to be bound by theory, in the present toner composition comprising a non cross linked latex, a cross linked latex, a wax, and a colorant, the cross linked latex is primarily used to increase the hot offset, while the wax is used to provide release characteristics. The ratio of the non cross linked latex to the cross linked latex, the wax content and the colorant content are selected to control the rheology of the toner.

In embodiments, the toner comprises non cross linked resin, cross linked resin or gel, wax, and colorant in an amount of about 68% to about 75% non cross linked resin, about 6% to about 13% cross linked resin or gel, about 6% to about 15% wax, and about 7% to about 13% colorant, by weight based upon the total weight of the composition wherein a total of the components is about 100%, although not limited thereto. In embodiments, the non cross linked resin, the cross linked resin or gel, the wax, and the colorant are present in an amount of about 71% non cross linked resin, about 10% cross linked resin or gel, about 9% wax, and about 10% colorant, by weight based upon the total weight of the composition.

In embodiments, the toner composition comprises a Mw in the range of about 25,000 to about 40,000 or about 35,000, a Mn in the range of about 9,000 to about 13,000 or about 10,000, and a Tg (onset) of about 48° C. to about 62° C. or about 54° C.

In embodiments of the present toner composition, the resultant toner possesses a shape factor of about 120 to about 140, and a particle circularity of about 0.930 to about 0.980.

Composite Toner Particle

In embodiments, the colorant comprises a black pigment such as carbon black. In yet another embodiment, the colorant is a pigment comprising black toner particles having a shape factor of about 120 to about 140 where a shape factor of 100 is considered to be spherical and a circularity of about 0.900 to about 0.980 as measured on an analyzer such as a Sysmex FPIA 2100 analyzer, where a circularity of 1.00 is considered to be spherical in shape.

In another feature, the colorant comprises a pigment dispersion, comprising pigment particles having a volume average diameter of about 50 to about 300 nanometers, water, and an anionic surfactant. For example, the colorant may comprise carbon black pigment dispersion such as with Regal 300 commercially available, prepared in an anionic surfactant and optionally a non-ionic dispersion to provide pigment particles having a size of from about 50 nanometers to about 300 nanometers. In embodiments, the surfactant used to disperse the carbon black is an anionic surfactant such as Neogen RK™, or TAYCAPOWDER BN 2060, although not limited thereto. Preferably, an ultimizer type equipment is used to provide the pigment dispersion, although media mill or other means can also be used.

Optionally, other various known colorants such as dyes or pigments may be present in the toner and the toner can optionally be used as an additional color in the xerographic engine besides black and is selected in an effective amount of, for example, from about 1 to about 65 percent by weight based upon the weight of the toner composition, in an amount of from about 1 to about 15 percent by weight based upon the weight of the toner composition, or in an amount of from about 3 to about 10 percent by weight, for example.

External Toner Additives

The toner compositions also include an externally applied additive package. The external additive package comprises at least one silica, at least one titania, and at least one type of spacer particles. The additive package is used as an external additive to the toner composition. That is, the toner particles per se are first formed, followed by mixing of the toner particles with the materials of the additive package. The result is that the additive package generally coats or adheres to external surfaces of the toner particles, rather than being incorporated into the bulk of the toner particles.

The first component of the additive package is silica, such as a surface treated silica. In embodiments, any suitable silica or surface treated silica can be used, and many varieties are known and available in the art. Such silicas can be used alone, as only one silica, or can be used in combination, such as two or more silicas. Where two or more silicas are used in combination, it is preferred (although not required) that one of the surface treated silicas be a decyl trimethoxysilane (DTMS) surface treated silica. Preferably, the silica of the decyl trimethoxysilane (DTMS) surface treated silica is a fumed silica.

Conventional surface treated silica materials are known and include, for example, TS-530 from Cabosil Corporation, with an 8 nanometer particle size and a surface treatment of hexamethyldisilazane; NAX50, obtained from DeGussa/Nippon Aerosil Corporation, coated with HMDS; H2050EP, obtained from Wacker Chemie, coated with an amino functionalized organopolysiloxane; CAB-O-SIL® fumed silicas such as for example TG-709F, TG-308F, TG-810G, TG-811F, TG-822F, TG-824F, TG-826F, TG-828F or TG-829F with a surface area from 105 to 280 m²/g obtained from Cabot Corporation; and the like. Such conventional surface treated silicas are applied to the toner surface for toner flow, triboelectric charge enhancement, admix control, improved development and transfer stability, and higher toner blocking temperature.

In other embodiments, other surface treated silicas can also be used. For example, a silica surface treated with polydimethylsiloxane (PDMS), can also be used. Specific examples of suitable PDMS-surface treated silicas include, for example, but are not limited to, RY50, NY50, RY200, RY200S and R202, all available from Nippon Aerosil, and the like.

Preferably, according to embodiments, the silica external additive is a surface treated silica. When so provided, the surface treated silica is preferably the only surface treated silica present in the toner composition. As described below, the external additive package also preferably includes large-sized sol-gel silica particles as spacer particles, which is distinguished from the surface treated silica described herein. Alternatively, for example where small amounts of other surface treated silicas are introduced into the toner composition for other purposes, such as to assist toner particle classification and separation, the surface treated silica is the only xerographically active surface treated silica present in the toner composition. Any other incidentally present silica thus does not significantly affect any of the xerographic printing properties. Preferably, the surface treated silica is the only surface treated silica present in the additive package applied to the toner composition. Other suitable silica materials are described in, for example, U.S. Pat. No. 6,004,714, the entire disclosure of which is incorporated herein by reference.

The second component of the additive package is a titania, and preferably in embodiments a surface treated titania. Preferably, the surface treated titania used in embodiments is a hydrophobic surface treated titania.

Conventional surface treated titania materials are known and include, for example, metal oxides such as TiO₂, for example MT-3103 from Tayca Corp. with a 16 nanometer particle size and a surface treatment of decylsilane; SMT5103, obtained from Tayca Corporation, comprised of a crystalline titanium dioxide core MT500B coated with DTMS; P-25 from Degussa Chemicals with no surface treatment; an isobutyltrimethoxysilane (i-BTMS) treated hydrophobic titania obtained from Titan Kogyo Kabushiki Kaisha (IK Inabata America Corporation, New York); and the like. Such surface treated titania are applied to the toner surface for improved relative humidity (RH) stability, triboelectric charge control and improved development and transfer stability.

While any of the conventional and available titania materials can be used, it is preferred in embodiments that specific surface treated titania materials be used, which have been found to unexpectedly provides superior performance results to the final toner composition. Thus, while any of the surface treated titania may be used in the external additive package, in embodiments it is preferred that the material be a “large” surface treated titania (i.e., one having an average particle size of from about 30 to about 50 nm, or from about 35 to about 45 nm, particularly about 40 nm). In particular, it has been found that the preferred surface treated titania provides one or more of better cohesion stability of the toners after aging in the toner housing, and higher toner conductivity, which increases the ability of the system to dissipate charge patches on the toner surface.

Specific examples of suitable surface treated titanias include, for example, but are not limited to, an isobutyltrimethoxysilane (i-BTMS) treated hydrophobic titania obtained from Titan Kogyo Kabushiki Kaisha (IK Inabata America Corporation, New York); SMT5103, obtained from Tayca Corporation or Degussa Chemicals, comprised of a crystalline titanium dioxide core MT500B coated with DTMS (decyltrimethoxysilane); and the like. The decyltrimethoxysilane (DTMS) treated titania is particularly preferred, in some embodiments.

Preferably, according to embodiments, only one titania, such as surface treated titania, is present in the toner composition. That is, in some embodiments, it is preferred that only one kind of surface treated titania be present, rather than a mixture of two or more different surface treated titanias.

The third component of the additive package is a spacer particle. Preferably, the spacer particle used in embodiments is a sol-gel silica.

Spacer particles, particularly latex or polymer spacer particles, are described in, for example, U.S. Patent Application Publication No. 2004-0137352 A1, the entire disclosure of which is incorporated herein by reference.

In one embodiment of the present disclosure, the spacer particles are comprised of latex particles. Any suitable latex particles may be used without limitation. As examples, the latex particles may include rubber, acrylic, styrene acrylic, polyacrylic, fluoride, or polyester latexes. These latexes may be copolymers or crosslinked polymers. Specific examples include acrylic, styrene acrylic and fluoride latexes from Nippon Paint (e.g. FS-101, FS-102, FS-104, FS-201, FS-401, FS-451, FS-501, FS-701, MG-151 and MG-152) with particle diameters in the range from 45 to 550 nm, and glass transition temperatures in the range from 65° C. to 102° C.

These latex particles may be derived by any conventional method in the art. Suitable polymerization methods may include, for example, emulsion polymerization, suspension polymerization and dispersion polymerization, each of which is well known to those versed in the art. Depending on the preparation method, the latex particles may have a very narrow size distribution or a broad size distribution. In the latter case, the latex particles prepared may be classified so that the latex particles obtained have the appropriate size to act as spacers as discussed above. Commercially available latex particles from Nippon Paint have very narrow size distributions and do not require post-processing classification (although such is not prohibited if desired).

In a further embodiment, the spacer particles may also comprise polymer particles. Any type of polymer may be used to form the spacer particles of this embodiment. For example, the polymer may be polymethyl methacrylate (PMMA), e.g., 150 nm MP1451 or 300 nm MP116 from Soken Chemical Engineering Co., Ltd. with molecular weights between 500 and 1500K and a glass transition temperature onset at 120° C., fluorinated PMMA, KYNAR®(polyvinylidene fluoride), e.g., 300 nm from Pennwalt, polytetrafluoroethylene (PTFE), e.g., 300 nm L2 from Daikin, or melamine, e.g., 300 nm EPOSTAR-S® from Nippon Shokubai.

In a preferred embodiment, the spacer particles are large sized silica particles. Thus, preferably, the spacer particles have an average particle size greater than an average particles size of the silica and titania materials, discussed above. For example, the spacer particles in this embodiment are sol-gel silicas. Examples of such sol-gel silicas include, for example, X24, a 150 nm sol-gel silica surface treated with hexamethyldisilazane, available from Shin-Etsu Chemical Co., Ltd.

The spacer particles on the surfaces of the toner particles are believed to function to reduce toner cohesion, stabilize the toner transfer efficiency and reduce/minimize development falloff characteristics associated with toner aging such as, for example, triboelectric charging characteristics and charge through. These external additive particles function as spacers between the toner particles and carrier particles and hence reduce the impaction of smaller conventional toner external surface additives, such as the above-described silica and titania, during aging in the development housing. The spacers thus stabilize developers against disadvantageous burial of conventional smaller sized toner external additives by the development housing during the imaging process in the development system. The spacer particles function as a spacer-type barrier, and therefore the smaller toner external additives are shielded from contact forces that have a tendency to embed them in the surface of the toner particles. The spacer particles thus provide a barrier and reduce the burial of smaller sized toner external surface additives, thereby rendering a developer with improved flow stability and hence excellent development and transfer stability during copying/printing in xerographic imaging processes. The toner compositions of the present disclosure thereby exhibit an improved ability to maintain their DMA (developed mass per area on a photoreceptor), their TMA (transferred mass per area from a photoreceptor) and acceptable triboelectric charging characteristics and admix performance for an extended number of imaging cycles.

Although the above components are generally known for use in forming toner compositions, it has been found that particular sizes and amounts of each of the additives, when combined together into a single external additive package, provides superior results. For example, superior results can be provided in terms of achieving target TMA values over a desired range of development voltages, enhanced developability and transfer efficiency, and the like.

The silica external additive is preferably present in an amount of from about 1 to about 4 percent by weight, based on a weight of the toner particles without the additive (i.e., in an amount of from about 0.5 to about 5 parts by weight additive per 100 parts by weight toner particle). More preferably, in embodiments, the silica is present in an amount of from about 1.5 or from about 1.8 to about 2.8 or to about 3 percent by weight. Further, in embodiments it is preferred that the silica has an average particle size of from about 10 to about 60 nm, or from about 20 to about 50 nm. At values outside these amount and size ranges, developability worsens, and the toner Q/d characteristics become undesirable. For example, when the amount of silica is too low, toner becomes too cohesive and may not flow at a sufficient rate; however, when the amount of silica is too high, toner triboelectric charge becomes more sensitive to relative humidity of the ambient atmosphere.

The titania external additive is preferably present in an amount of from about 0.5 to about 4 percent by weight, based on a weight of the toner particles without the additive. More preferably, in embodiments, the titania is present in an amount of from about 0.5 or from about 1.5 to about 2.5 or to about 3 percent by weight. Further, in embodiments it is preferred that the titania has an average particle size of from about 10 to about 60 nm, or from about 20 to about 50 nm, such as about 40 nm. At values outside these amount and size ranges, developability worsens, and the toner Q/d characteristics become undesirable. For example, titania is added to increase uniformity of toner charge distribution at the particle surface, and to compensate the sensitivity of silica to moisture in the atmosphere. However, when the amount of titania is too high, triboelectric charge can be significantly decreased.

The spacer particles are preferably present in an amount of from about 0.3 to about 2.5 percent by weight, based on a weight of the toner particles without the additive. More preferably, in embodiments, the spacer particles are present in an amount of from about 0.5 or from about 0.6 to about 1.8 or to about 2.0 percent by weight. Further, in embodiments it is preferred that the spacer particles have an average particle size of from about 60 to about 300 nm, or from about 75 to about 205 nm, such as from about 100 nm to about 150 nm. At values outside these amount and size ranges, developability worsens, and the toner Q/d characteristics become undesirable. For example, the spacer particles decrease adhesion of toner particles to surfaces in the system (such as donor roll, photoreceptor, etc.) and thus to increase developability and transfer efficiency, and to prevent toner filming. However, if the amount of spacer is too high, it can significantly decrease both toner charge and its ability to flow.

The foregoing size measurements can be measured by, for instance, transmission electron microscopy (TEM) or calculated (assuming spherical particles) from a measurement of the gas absorption, or BET, surface area.

The combined additive package of silica, titania, and spacer particles are specifically applied to the toner surface with the total coverage of the toner ranging from, for example, as low as about 50% to as high as about 250% theoretical surface area coverage (SAC), preferably from about 55% or about 70% to about 150 theoretical surface area coverage (SAC), where the theoretical SAC (hereafter referred to as SAC) is calculated assuming all toner particles are spherical and have a diameter equal to the volume median diameter of the toner as measured in the standard Coulter Counter method, and that the additive particles are distributed as primary particles on the toner surface in a hexagonal closed packed structure. Another metric relating to the amount and size of the additives is the sum of the “SAC×Size” (surface area coverage in percent times the primary particle size of the additive in nanometers) for each of the silica, titania, and spacer particles, or the like, for which all of the additives should, more specifically, have a total SAC×Size range of, for example, from about 500 to about 8,000, preferably in embodiments from about 2,000 to about 5,000.

Thus, for example, in one embodiment, the external additive package for the toner composition comprises silica in an amount of from about 1.8 to about 2.8 percent, titania in an amount of from about 1.5 to about 2.5 percent, and spacer particles in an amount of from about 0.6 to about 1.8 percent, where the percentages are by weight, based on a weight of the toner particles without the additive. In another embodiment, the external additive package for the toner composition comprises silica in an amount of from about 1.9 to about 2.0 percent, titania in an amount of from about 1.7 to about 1.8 percent, and spacer particles in an amount of from about 1.7 to about 1.8 percent by weight. A particularly preferred external additive package for the toner composition comprises about 1.963 percent silica, about 1.773 percent titania, and about 1.724 percent spacer particles.

For further enhancing the positive charging characteristics of the toner developer compositions, and as optional components there can be incorporated into the toner or on its surface charge enhancing additives inclusive of alkyl pyridinium halides, reference U.S. Pat. No. 4,298,672, the disclosure of which is totally incorporated herein by reference; organic sulfate or sulfonate compositions, reference U.S. Pat. No. 4,338,390, the disclosure of which is totally incorporated herein by reference; distearyl dimethyl ammonium sulfate; bisulfates, and the like, and other similar known charge enhancing additives. Also, negative charge enhancing additives may also be selected, such as aluminum complexes, like BONTRON E-88®, and the like. These additives may be incorporated into the toner in an amount of from about 0.1 percent by weight to about 20 percent by weight, and more specifically from about 1 to about 3 percent by weight.

Developer Compositions

Once the toner particles are formed, including with application of the external additive package, developer compositions may then be formed employing the toner particles. For the formulation of developer compositions, there are mixed with the toner particles carrier components, particularly those that are capable of triboelectrically assuming an opposite polarity to that of the toner composition. For example, the carrier particles may be selected to be of a positive polarity enabling the toner particles, which are negatively charged, to adhere to and surround the carrier particles. Illustrative examples of carrier particles include iron powder, steel, nickel, iron, ferrites, including copper zinc ferrites, and the like. Additionally, there can be selected as carrier particles nickel berry carriers as illustrated in, for example, U.S. Pat. No. 3,847,604.

The selected carrier particles can be used with or without a coating of any desired and/or suitable type. The carrier particles may also include in the coating, which coating can be present in one embodiment in an amount of from about 0.1 to about 5 weight percent such as from about 0.5 to about 1.5 percent, conductive substances such as carbon black in an amount of from about 5 to about 30 percent by weight such as from about 15 to about 25 percent by weight and/or insulative substances such as melamine in an amount from about 5 to about 15 percent by weight. Polymer coatings not in close proximity in the triboelectric series may be selected as the coating, including, for example, KYNAR® and polymethylmethacrylate mixtures. Coating weights can vary as indicated herein; generally, however, from about 0.3 to about 2, and preferably from about 0.5 to about 1.5 weight percent coating weight is selected. For example, one exemplary coating, which can be present in an amount of from about 0.5 to about 1.5 percent by weight of the toner particles, includes a mixture of from about 75 to about 85 percent by weight polymethylmethacrylate and from about 25 to about 15 percent by weight carbon black.

The diameter of the carrier particles, preferably spherical in shape, is generally from about 35 microns to about 500 microns, and preferably from about 35 to about 75 microns, thereby permitting them to possess sufficient density and inertia to avoid adherence to the electrostatic images during the development process. For use with emulsion aggregation toner compositions, such as described above, the carrier particles preferably have an average particle size of less than about 100 microns, such as less than about 75 microns or less than about 65 microns, for example from about 35 to about 65 microns. The carrier component can be mixed with the toner composition in various suitable combinations, such as from about 1 to 5 parts per toner to about 100 parts to about 200 parts by weight of carrier.

In one embodiment, the carrier particles are atomized steel cores having a coating of polymethylmethacrylate including about 20% by weight carbon black. The steel cores have an average particle size of about 65 microns.

The carrier particles can also be selected to have any desired conductivity. For example, in embodiments, the carrier particles have a conductivity of from about 10⁻⁴ to about 10⁻⁸ (ohm-cm)⁻¹, such as from about 10⁻⁵ to about 10⁻⁷ (ohm-cm)⁻¹.

Development Processes

The toner and developer compositions of the present disclosure can be selected for electrophotographic, especially xerographic, imaging and printing processes, including digital processes. The toners may be used with particular advantage in image development systems employing hybrid scavengeless development (HSD) in which an aggressive developer housing is employed that has a tendency to beat conventional smaller sized external surface additives into the surface of the toner particles, thereby causing the toner properties to degrade upon aging. The toner and developer compositions may also be used in an image development system employing hybrid jumping development (HJD), such as described in U.S. Pat. Nos. 5,890,042 and 5,983,053, the entire disclosure of which are incorporated herein by reference, in which a development (donor) roll is powered by two development fields (potentials across an air gap). The first field is the ac jumping field, which is used for toner cloud generation and has a typical potential of about 2.6k volts peak to peak at 3.25k Hz frequency; the second field is the dc development field, which is used to control the amount of developed toner mass on the photoreceptor. Of course, the toner may be used in an image development system employing any type of development scheme without limitation, including, for example, conductive magnetic brush development (CMB), which uses a conductive carrier, insulative magnetic brush development (IMB), which uses an insulated carrier, semiconductive magnetic brush development (SCMB), which uses a semiconductive carrier, etc.

In particular embodiments, the toner and developer compositions of this disclosure are particularly well suited for use in Xerox® printers, copiers and multifunctional devices that use HJD development subsystem, including the Xerox® Nuvera™ series of development systems, such as the 100 Xerox® Nuvera™ 100 and 120 systems, the Xerox® Document Centre™ 470, WorkCentre Pro 65/75/90, DocuTech™75, DocuTech™90, and the like.

Such development systems and toner/developer combinations exhibit, for example, a number of properties that enable the production of high quality printed images. For example, the combination of these development systems and the disclosed toner/developer combinations provide a transfer efficiency (both fir new and aged toner) of greater than about 0.8 and most preferably greater than about 0.9. TMA at t=0 (new toner) is greater than about 0.4 milligrams per square centimeter. Development stability is also an important parameter that can be measured as the percentage of sustained TMA after printing 750 blank letter-sized pages thus subjecting the developer to mechanical stress in the absence of toner throughput that results in deterioration of toner developability. For the combination of these Nuvera™ development systems and the disclosed toner/developer combinations, the development stability is greater than 70%. The development system/developer combinations also exhibit desirable q/d characteristics. For example, the maximum (i.e., the least negative) toner q/d after admix is preferably below 0 femto Coulombs per micron, indicating that no wrong-sign (positive) charged toner is present.

An example is set forth herein below and is illustrative of different compositions and conditions that can be utilized in practicing the disclosure. All proportions are by weight unless otherwise indicated. It will be apparent, however, that the disclosure can be practiced with many types of compositions and can have many different uses in accordance with the disclosure above and as pointed out hereinafter.

### EXAMPLES

Preparation of Base Toner Particles:

Base toner particles, i.e., without any external surface additives, are prepared as follows.

Preparation of Non Cross Linked Latex by Emulsion Polymerization

A styrene/butyl acrylate polymer latex (latex 1) is prepared by semi-continuous emulsion polymerization with a 77.5/22.5 composition ratio (by weight). The polymer also contains 0.35 pph of crosslinking agent (decanedioldiacrylate) and is acid functionalized by the inclusion of 3.0 pph β-carboxyethyl acrylate (β-CEA). The molecular weight is controlled by the addition of 1.57 pph dodecanethiol; 0.4 pph is added during the first half of the monomer feed and the remaining 1.17 pph is added in the second half of the monomer feed. The monomer is fed to the reactor as an oil-in-water emulsion prepared with DOWFAX anionic surfactant. The reaction is conducted at 75° C. and the monomer is fed in over 200 minutes. The initiator used is ammonium persulfate at 1.5 pph. Latex 1 has a Mw of 35,400, an Mn of 11,800, an onset glass transition temperature (Tg) of 51° C., a particle size of 210 nm and 40% solids.

Preparation of Cross Linked Latex by Emulsion Polymerization

A second styrene/butyl acrylate latex (latex 2) is prepared by semi-continuous emulsion polymerization with a 65/35 composition ratio (by weight). The polymer also contains 1.0 pph of crosslinking agent (divinyl benzene) and is acid functionalized by the inclusion of 3.0 pph □-CEA. The monomer is fed to the reactor as an oil-in-water emulsion prepared with NEOGEN RK anionic surfactant. The reaction is conducted at 75° C. and the monomer is fed in over 100 minutes. The initiator used is ammonium persulfate at 1.7 pph. Latex 2 has an onset glass Tg of 43° C., a particle size of 48 nm and 20% solids. The latex has extensive gelation, and thus molecular weight properties can not be reliably determined.

Preparation of Toner

The prepared latexes are mixed with a carbon black pigment dispersion and a wax dispersion, and then flocculated with polyaluminum chloride and calcium chloride at room temperature. The slurry is homogenized and then heated with mixing to control particle growth. Once the appropriate size of flocculated particles is achieved, as measured on a Beckman Coulter counter, a second lot of latex 1 is added to form a shell layer. Once the desired final size is achieved, e.g., 5.0 to 6.7 microns, the particle growth is stopped by the addition of base to adjust the pH to 7. The slurry is then heated to 95° C. and the particles are allowed to coalesce at the appropriate pH until the desired particle shape is achieved, circularity being determined by Malvern Sysmex Flow Particle Image Analyzer FPIA-2100). The final toner contains 10% wt R330 pigment, 9% wt cross-linked resin and 9% wt wax.

Preparation of Carrier Particles:

Carrier particles, for use in forming developer compositions, are prepared as follows. The carrier particles comprise 65 μm atomized steel core (supplied by Hoeganaes North America Corporation). The steel core particles are coated with 1% by weight of a polymer mixture comprising 80% by weight poly (methyl methacrylate) and 20% by weight carbon black, at 200° C.

Preparation of Developer Compositions:

Ten developer compositions are prepared as follows. Using the base toner particles described above, an external surface additive package is applied to the base toner particles to form toner compositions. Specifically, the external additive package includes varying amounts of silica (DTMS-treated silica), titania (SMT-5103), and spacer particles (sol-gel silica X24). The amounts of the components are shown in the following table, where all percentages are by weight, based on a weight of the toner particles without the additive.

| | Silica | Titania | Spacer particles |
|---|---|---|---|
| Toner Sample No. | (DTMS-silica) | (SMT-5103) | (sol-gel silica X24) |
| 1 | 1.8 | 2.6 | 0.6 |
| 2 | 2.8 | 2.6 | 0.6 |
| 3 | 1.8 | 4.4 | 0.6 |
| 4 | 2.8 | 4.4 | 0.6 |
| 5 | 1.8 | 2.6 | 1.8 |
| 6 | 2.8 | 2.6 | 1.8 |
| 7 | 1.8 | 4.4 | 1.8 |
| 8 | 2.8 | 4.4 | 1.8 |
| 9 | 2.3 | 3.5 | 1.2 |
| 10 | 1.963 | 1.773 | 1.724 |

Developer compositions are prepared by combining 769 g of the above carrier particles with 31 g of the prepared toner composition (with external additives). The toner and carrier are mixed in a 1 litre glass jar and charged into a paint shaker at ambient conditions for 30 min.

Developer Testing:

Seven of the developers prepared above are tested for development performance in a Xerox® DC265 printer. Specifically, developers prepared using Toner Samples 1, 2, 4, 6, 7, 8, and 10 are tested.

The developer compositions are transferred into a Xerox® DC265 developer housing. AC development voltage (“development voltage” is the potential difference between donor roll and exposed area of the photoreceptor) is set at a constant value of 2225 Volts peak to peak. TMA is measured by blowing the unfused toner off paper. DC development voltage is varied between 50 V and 400 V, and TMA is measured as a function of development voltage. The nominal development voltage is selected in order to obtain a TMA of 0.55 mg/cm². DMA is measured by collecting developed toner off a solid area image on the photoreceptor on a Millipore filter with a vacuum pump. Toner to carrier weight ratio and charge to mass ratio (Q/M) are measured by using a toner blow-off cage. Charge to diameter (q/d) ratio is measured in a charge spectrograph by measurements toner deflection from the zero-field dot position.

The above measurements are made for new (as-prepared) developer, stress aged developer obtained by aging without toner throughout by making 750 blank letter-sized prints, and for fresh toner admix (toner to carrier weight ratio is reduced to 3%, and 1.5 wt. % of fresh toner is added). The total observed loss of TMA after 750 blank copies is attributed to developer aging. The results are provided in the following Table.

| | 1 | 2 | 4 | 6 | 7 | 8 | 10 |
|---|---|---|---|---|---|---|---|
| Transfer efficiency at | 0.820 | 0.880 | 0.840 | 0.870 | 0.770 | 0.890 | 0.92 |
| t = 0 | | | | | | | |
| Transfer efficiency | 0.950 | 0.966 | 0.980 | 0.940 | 0.890 | 0.770 | 0.99 |
| after aging | | | | | | | |
| Initial TMA at a DC | 0.400 | 0.403 | 0.470 | 0.429 | 0.490 | 0.510 | 0.55 |
| bias of 150 V | | | | | | | |
| Development | 52.3% | 65.8% | 93.4% | 67.6% | 65.9% | 71.0% | 73.6% |
| stability | | | | | | | |
| Maximum (least | 0.046 | 0.015 | 0.000 | −0.046 | 0.000 | 0.000 | 0.000 |
| positive) q/d after | | | | | | | |
| admix | | | | | | | |

From the above results, the following conclusions are drawn regarding desirable percent loading of the various external additive components:

In terms of transfer efficiency at t=0, it is desired that this parameter be greater than about 0.9. To achieve this desired value, the silica should be present in an amount of at least about 2% by weight, and the titania should be present in an amount of less than about 2.9% by weight.

In terms of transfer efficiency after aging, it is desired that this parameter be greater than about 0.9. To achieve this desired value, the titania should be present in an amount of less than about 2.9% by weight.

In terms of TMA at t=0, it is desired that this parameter be greater than about 0.4. To achieve this desired value, the spacer particles should be present in an amount of at least about 0.6% by weight.

In terms of development stability to aging, it is desired that this parameter be within the range of greater than 70%. To achieve this desired range, the silica should be present in an amount of at least about 1.95% by weight, and the spacer particles should be present in an amount of at least about 1.8% by weight.

In terms of the presence of wrong-sign toner charge, it is desired that the maximum (least negative) q/d is about 0 or below. To achieve this desired value, the silica should be present in an amount of at least about 1.9,% by weight, and the spacer particles should be present in an amount of at least about 1.7% by weight.

Of course, it is apparent that at least some of the above parameters for the silica, titania, and spacer particles content overlap and/or are contradictory to each other. In these instances, it is understood that some trade-off of one property in favor of another property may be required.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A toner composition comprising:
toner particles comprising a resin, a wax, and a colorant; and
external additives applied on an exterior surface of said toner particles, comprising silica, titania, and spacer particles.

2. The toner of claim 1, wherein the toner particles are made by an emulsion/aggregation coalescence process.

3. The toner of claim 2, wherein emulsion/aggregation coalescence process comprises:
mixing said resin, said wax, said colorant, and an optional coagulant to form toner size aggregates;
optionally adding additional resin to the formed toner size aggregates to provide a shell over the formed aggregates;
heating the toner size aggregates to form toner particles; and
optionally isolating the toner particles.

4. The toner of claim 1, wherein the resin comprises a first resin substantially free of cross linking and a second cross linked resin.

5. The toner of claim 1, wherein the external additives comprise silica in an amount of from about 1.8 to about 2.8 percent, titania in an amount of from about 1.5 to about 2.5 percent, and spacer particles in an amount of from about 0.6 to about 1.8 percent, based on a weight of the toner particles.

6. The toner of claim 1, wherein the external additives comprise silica in an amount of from about 1.9 to about 2.0 percent, titania in an amount of from about 1.7 to about 1.8 percent, and spacer particles in an amount of from about 1.7 to about 1.8 percent, based on a weight of the toner particles.

7. The toner of claim 1, wherein the silica has an average particle size of from about 10 to about 60 nm.

8. The toner of claim 1, wherein the titania has an average particle size of from about 10 to about 60 nm.

9. The toner of claim 1, wherein the spacer particles are sol-gel silica particles having an average particle size of from about 60 to about 300 nm.

10. The toner of claim 1, wherein the external additives comprise:
silica in an amount of from about 1.8 to about 2.8 percent and having an average particles size of from about 20 to about 50 nm;
titania in an amount of from about 1.5 to about 2.5 percent and having an average particles size of from about 20 to about 50 nm; and
spacer particles in an amount of from about 0.6 to about 1.8 percent and having an average particles size of from about 100 to about 150 nm,
where the percentages are based on a weight of the toner particles.

11. The toner of claim 1, wherein the silica is a surface treated silica.

12. The toner of claim 1, wherein the silica is a surface treated silica treated with a material selected from the group consisting of decyl trimethoxysilane, hexamethyldisilazane, an amino functionalized organopolysiloxane, polydimethylsiloxane, and mixtures thereof.

13. The toner of claim 1, wherein the titania is a surface treated titania.

14. The toner of claim 1, wherein the titania is a surface treated titania treated with a material selected from the group consisting of decylsilane, decyl trimethoxysilane, isobutyltrimethoxysilane, and mixtures thereof.

15. The toner of claim 1, wherein the spacer particles are selected from the group consisting of latex particles, polymer particles, and sol-gel silica particles, wherein said spacer particles have an average particle size greater than an average particles size of said silica and said titania.

16. The toner of claim 1, wherein the toner particles comprise about 68% to about 88% resin, about 6% to about 15% wax, and about 7% to about 13% colorant, by weight based upon the total weight of the toner particles and wherein a total of the components is about 100%.

17. The toner of claim 16, wherein the toner particles comprise about 68% to about 75% resin substantially free of cross linking and about 6% to about 13% cross linked resin, based upon the total weight of the composition and wherein a total of the components is about 100%.

18. A developer comprising:
the toner of claim 1; and
carrier particles.

19. The developer of claim 18, wherein the carrier particles have an average particle size of less than about 100 microns.

20. The developer of claim 18, wherein the carrier particles comprise steel cores coated with from about 0.5 to about 1.5 percent by weight of the toner particles, of a mixture comprising from about 75 to about 85 percent by weight polymethylmethacrylate and from about 25 to about 15 percent by weight carbon black.

21. The developer of claim 18, wherein the carrier particles have a conductivity of from about 10⁻⁵ to about 10⁻⁷ (ohm-cm)⁻¹.

22. A method of making a toner, comprising:
mixing at least resin particles, colorant particles, and a coagulant;
forming toner size aggregates in said mixture by an emulsion aggregation process;
optionally adding additional resin substantially free of cross linking to the formed aggregates to provide a shell over the formed aggregates;
optionally isolating the toner size aggregates; and
applying on an exterior surface of said toner size aggregates external additives comprising silica, titania, and spacer particles.

23. An electrographic image development device, comprising:
a development system; and
a toner composition comprising:
toner particles comprising a resin, a wax, and a colorant; and
external additives applied on an exterior surface of said toner particles, comprising silica, titania, and spacer particles.

24. The electrographic image development device of claim 23, wherein the electrographic image development device exhibits the following properties:
a transfer efficiency at t=0 of greater than about 0.8;
a transfer efficiency after developer aging of greater than about 0.9;
TMA at t=0 of greater than about 0.4 miligrams per square centimeter;
development stability to aging is greater than 70%; and
maximum q/d is below about 0 after fresh toner admix.
